(19) United States
(12) Patent Application Publication
(10) Pub. No.: US 2026/0225646 A1
(43) Pub. Date: Aug. 6, 2026

(54) VEHICLE ANTI-HYDROPLANING SYSTEM

(71) Applicant: NISSAN NORTH AMERICA, INC., Franklin, TN (US)

(72) Inventor: David GRANT, Commerce, MI (US)

(21) Appl. No.: 19/045,342

(22) Filed: Feb. 4, 2025

(51) Int. Cl. B62D 6/00

(52) U.S. Cl. CPC B62D 6/00

(57) ABSTRACT

A vehicle anti-hydroplaning system includes a steering system, a sensor and a controller. The steering system is configured to operate steerable wheels of a vehicle. The sensor is configured to sense a condition of the steerable wheels of the vehicle. The controller is configured to determine that and the vehicle is in a hydroplaning state based on the condition sensed by the sensor and is configured to perform a mitigation operation using the steering system to improve traction of the steerable wheels of the vehicle.

### BACKGROUND

### Technical Field

The present disclosure generally relates to a vehicle anti-hydroplaning system. More specifically, the present disclosure relates to a vehicle anti-hydroplaning system that performs a mitigation operation to improve traction of the steerable wheels of the vehicle.

### Background Information

A vehicle can hydroplane on a road or other surface when a layer of water builds between the wheels of the vehicle and the road surface, leading to a loss of traction that prevents the vehicle from responding to control inputs. If hydroplaning occurs to both the front (or steerable wheels) of the vehicle simultaneously, the vehicle can become uncontrollable.

### SUMMARY

As can be understood, hydroplaning can create a dangerous situation for vehicle occupants, the vehicle itself and the surrounding vehicles, people and objects. It has been determined that an improved system to prevent or correct hydroplaning is desired.

In view of the state of the known technology, one aspect of the present disclosure is to provide a vehicle anti-hydroplaning system comprising a steering system, a sensor and a controller. The steering system is configured to operate a steerable wheel of a vehicle. The sensor is configured to sense a condition of the steerable wheel of the vehicle. The controller is configured to determine that and the vehicle is in a hydroplaning state based on the condition sensed by the sensor and is configured to perform a mitigation operation using the steering system to improve traction of the steerable wheel of the vehicle.

Another aspect of the present disclosure is to provide a method of increasing tire traction in a vehicle, the method comprising sensing, via a sensor, a condition of the steerable wheel of the vehicle, determining, via a controller, that and the vehicle is in a hydroplaning state based on the condition sensed by the sensors, and performing, via the controller, a mitigation operation using a steering system to improve traction of the steerable wheel of the vehicle.

Another aspect of the present disclosure is to provide a non-transitory machine-readable medium storing instructions which, when executed by one or more processor, causes the one or more processor to execute the methods disclosed herein.

### BRIEF DESCRIPTION OF THE DRAWINGS

Referring now to the attached drawings which form a part of this original disclosure:

FIG. 1 is a schematic of a vehicle including one embodiment of the vehicle anti-hydroplaning system of the present disclosure;

FIG. 2 is a schematic showing the vehicle anti-hydroplaning system of the present disclosure;

FIG. 3A illustrates a wheel under normal conditions in contact with a road surface;

FIG. 3B illustrates the wheel of FIG. 3A in a hydroplaning condition;

FIG. 4 illustrates a vehicle hydroplaning on a road;

FIG. 5 illustrates the vehicle anti-hydroplaning system of the present disclosure sweeping the steerable wheels of the vehicle;

FIG. 6 illustrates the vehicle in a stabilized condition after the sweeping of FIG. 6 has been performed; and

FIG. 7 is a flow chart illustrating the process of the controller of the vehicle anti-hydroplaning system of the present disclosure.

It should be noted that these figures are intended to illustrate the general characteristics of methods, structure and/or materials utilized in certain illustrative embodiments and to supplement the written description provided below. These drawings are not to scale and may not precisely reflect the precise structural or performance characteristics of any given embodiment and should not be interpreted as defining or limiting the range of values or properties encompassed by illustrative embodiments unless specified.

### DETAILED DESCRIPTION

Selected embodiments will now be explained with reference to the drawings. It will be apparent to those skilled in the art from this disclosure that the following descriptions of the embodiments are provided for illustration only and not for the purpose of limiting the disclosure as defined by the appended claims and their equivalents.

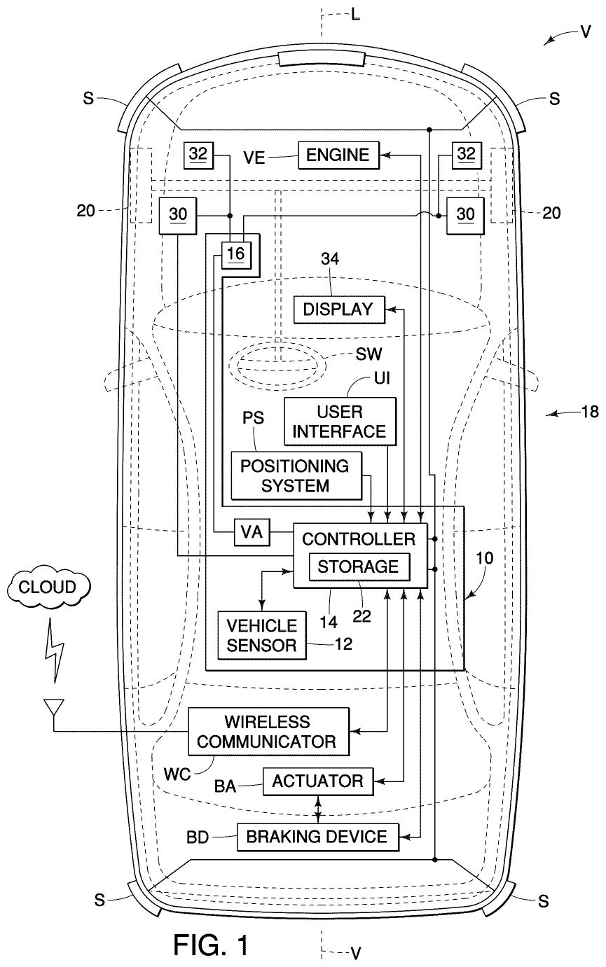

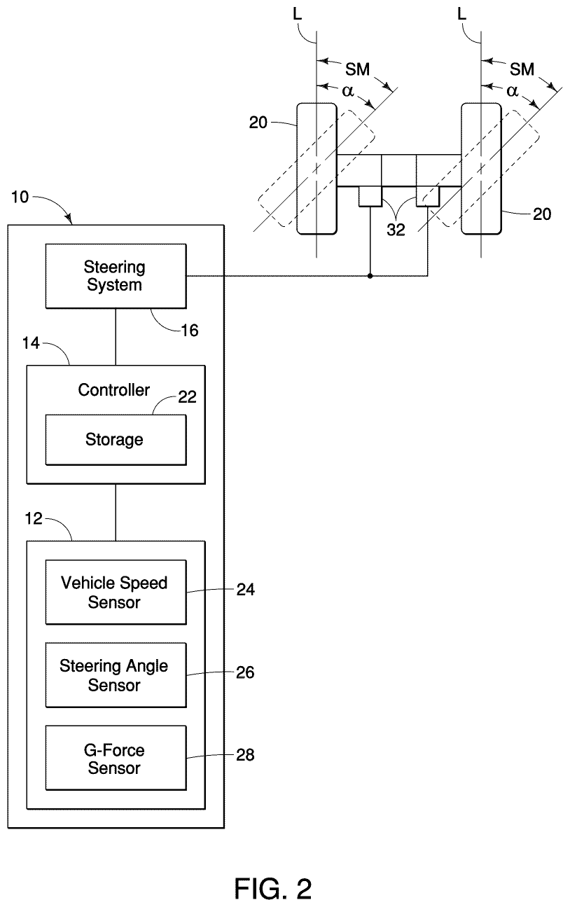

Referring initially to FIGS. 1 and 2, a vehicle anti-hydroplaning system 10 of the present disclosure is illustrated in accordance with a first embodiment. The vehicle anti-hydroplaning system 10 includes a sensor 12 and a controller 14 and a steering system 16.

As can be understood, the vehicle anti-hydroplaning system 10 can be a stand-alone system, or the vehicle anti-hydroplaning system 10 can be a component or portion of a vehicle control system 18. The vehicle V controlled by the vehicle control system 18 can be any suitable vehicle. Here, the vehicle V is illustrated as a sedan; however, the illustration of the sedan is merely exemplary and the vehicle V can be any suitable vehicle, including but not limited to an SUV, a truck, a pick-up truck, a sports car, a hatchback, an autonomous vehicle, a semiautonomous vehicle, or any other desired vehicle. Furthermore, the vehicle can include four wheels, three wheels, two wheels or any number of wheels. For example, the vehicle anti-hydroplaning system 10 can be operational with a motorcycle or other vehicle having only one steerable wheels. In which case, the vehicle anti-hydroplaning system 10 would operate using only the one steerable wheel.

As also seen in FIG. 1, the vehicle V is also equipped with a vehicle engine VE and other conventional vehicle components, such as, a braking device BD or sensors S, etc. The vehicle engine VE generates a torque output of the vehicle V in accordance with the operation of the vehicle V pedal by the driver. The torque output generated by the vehicle engine VE is then transferred to the rear wheels RW and/or the steerable wheels 20 (e.g., the first and second steerable or front wheels) of the vehicle V through the transmission and the drivetrain of the vehicle V in a conventional manner. The vehicle engine VE can be further equipped with an electronic control unit (ECM). In particular, the ECM controls a torque output of the vehicle engine VE. In the illustrated embodiment, the vehicle engine VE can be an internal combustion engine or an electric engine. Alternatively, the vehicle V can be a hybrid vehicle V, or be operated by a hydrogen powertrain.

In the illustrated embodiment, the vehicle control system 18 includes an electronic control unit or controller 14 (e.g., a processor). The vehicle control system 18 can also include a computer memory (storage 22). The electronic controller 14 includes one or more processor(s) for controlling the various operations of the vehicle V, as will be further described. In the illustrated embodiment, the electronic controller 14 is preferably a microcomputer (MPU) or central processing unit (CPU). The electronic controller 14 is formed of one or more semiconductor chips that are mounted on a circuit board. The term “electronic control unit” or “electronic controller 14” as used herein refers to hardware that executes a software program, and does not include a human being. The MPU or CPU may be one or more integrated circuits having firmware for causing the circuitry to complete the activities described herein. Of course, any number of other analog and/or digital components capable of performing the functionality described below can be provided in place of, or in conjunction with the electronic controller 14.

The controller 14 can also include other conventional components such as an input interface circuit, an output interface circuit, and storage devices such as a ROM (Read Only Memory) device and a RAM (Random Access Memory) device. The microcomputer of the controller 14 is programmed to control the vehicle control system 18. The memory circuit stores processing results and control programs such as ones for sensors S, the vehicle sensor 12, a vehicle actuator VA, a positioning system PS, a wireless communicator WC, the steering system 16 and the braking device BD that are run by the processor circuit. The controller 14 is operatively coupled to the sensors, the vehicle sensor 12, the vehicle actuator VA, the positioning system PS, wireless communicator WC, the steering system 16 and the braking device BD in a conventional manner. The internal RAM of the controller 14 stores statuses of operational flags and various control data. The internal ROM of the controller 14 stores the-information for various operations. The controller 14 is capable of selectively controlling any of the components of the vehicle control system 18 in accordance with the control program.

The computer memory (storage 22) is any memory or storage device. Here, for example, the computer memory (storage 22) includes a transitory or non-transitory computer-readable medium with the sole exception of a transitory propagating signal. Thus, the computer memory (storage 22) can include nonvolatile memory and volatile memory, and can include at least one of an internal memory, or other type of memory devices such as a read-only memory (ROM), an erasable programmable read only memory (EPROM), an electrically erasable programmable read-only memory (EEPROM), a random access memory (RAM), a hard disk, a flash drive, etc. The computer memory (storage 22) stores various control processes or control programs as well as information or data used by the electronic controller 14. Thus, the computer memory (storage 22) is electrically connected to the electronic controller 14. In one embodiment, computer memory (storage 22) is included in or is considered part of the electronic controller 14. In this way, the electronic controller 14 can retrieve data and access programs stored in the computer memory (storage 22), and can store data to the computer memory (storage 22). The computer memory (storage 22) preferably includes non-volatile memory that is configured to store various control programs (e.g., a program for a vehicle V control method, etc.), operational data, component identification data, etc.

In the illustrated embodiment, the vehicle control system 18 includes environmental sensors (sensors S). The environmental sensors detects the traveling environment of the vehicle V. For example, the environmental sensors can be equipped with one or more unidirectional or omnidirectional external cameras that take moving or still images of the traveling environment or surroundings of the vehicle V. The environmental sensors can also include infrared detectors, ultrasonic detectors, radar detectors, photoelectric detectors, magnetic detectors, acceleration detectors, acoustic/sonic detectors, gyroscopes, lasers or any combination thereof. The environmental sensors can also include object-locating sensing devices including range detectors, such as FM-CW (Frequency Modulated Continuous Wave) radars, pulse and FSK (Frequency Shift Keying) radars, sonar and Lidar (Light Detection and Ranging) devices. The data from the environmental sensors can be used to detect the traveling environment of the vehicle V. In any case, in the illustrated embodiment, the environmental sensors include at least one of a lidar sensor (Lidar), a radar sensor (radar) and an image sensor (camera).

In the illustrated embodiment, the vehicle control system 18 further includes a vehicle sensor 12, a vehicle actuator VA, a satellite navigation device or positioning system PS a wireless communicator WC. As illustrated un FIG. 2, the vehicle sensor 12 includes various sensors to detect driving states of the vehicle V. For example, the vehicle sensor 12 includes a vehicle speed sensor 24, a yaw rate sensor, a torque sensor, etc. The vehicle speed sensor 24 can measure wheel speed of the vehicle V in a conventional manner to detect current vehicle speed of the vehicle V. The yaw rate sensor detects the yaw rate generated in the vehicle V in a conventional manner. The torque sensor can measure the torque on the crankshaft of the vehicle engine VE in a conventional manner.

In one embodiment, the vehicle sensor 12 can include a plurality of inertial measurement units 30 (IMU). An IMU is an electronic device that measures and reports a force applied to the vehicle V, the angular rate of the vehicle V, and the orientation of the vehicle V, using a combination of accelerometers, gyroscopes, or any other suitable device. The IMUs 30 can detect the linear acceleration the vehicle V using one or more of the accelerometers and the rotational rate of the vehicle V using one or more of the gyroscopes. The IMUs 30 are often incorporated into or in communication with the positioning system PS, which utilizes the raw IMU measurements to calculate attitude, angular rates, linear velocity, and position relative to a global reference frame.

The vehicle can include a brake actuator BA and steering actuators 32. The brake actuator BA and steering actuators 32 are operatively connected to the electronic controller 14 to operate vehicle components of the vehicle V according to the autonomous driving control and/or the driving assist control. The steering actuators 32 are operated by the steering system 16 of the vehicle V to control the steering angle of the steerable wheels 20 of the vehicle V. The brake actuator BA operates the braking device BD to control the deceleration of the vehicle V. In the illustrated embodiment, the electronic controller 14 can be in communication with the ECM of the vehicle engine VE to operate the vehicle engine VE to control the acceleration of the vehicle V. However, the vehicle actuator VA can further include an accelerator opening actuator that operates the throttle of the vehicle engine VE to control the acceleration of the vehicle V.

The vehicle control system 18 can include additional aspects of vehicle control including but not limited to electronic stability control, traction control, antilock braking, adaptive cruise control, automatic braking, lane keeping and any other vehicle control system desired.

As can be understood, in one embodiment, the vehicle V is operated by a drive by wire system. The drive by wire system uses the steering actuators 32, in place of mechanical linkages, to operate the steerable wheels 20 of the vehicle V. Sensors detect the movement of the steering wheel SW and send this information to the controller 14. The controller 14 then sends instructions to the steering actuators 32, which turn the wheels 20 to steer the vehicle V.

The positioning system PS includes a global navigation satellite system (GNSS) receiver. In the illustrated embodiment, the GNSS receiver can be a global positioning system (GPS) receiver, for example. The positioning system PS receives radio waves from a plurality of navigation satellites to obtain information that represents, for example, a current vehicle heading of the vehicle V, a current vehicle position of the vehicle in two or three dimensions, a current vehicle angular orientation of the vehicle, or a combination thereof.

The wireless communicator WC is in wireless communications with at least one of cloud services and a vehicle network. The wireless communicator WC is further configured to communicate with other vehicles or device as described herein to facilitate control of the vehicle V. The wireless communicator WC is a hardware device capable of transmitting and/or receiving an analog or digital signal wirelessly via an antenna. The terms “wireless communicator WC” as used herein include a receiver, a transmitter, a transceiver, or a transmitter-receiver, for example.

In the illustrated embodiment, the vehicle control system 18 can be further equipped with any other vehicle components, such as an operator interface with a display device DD or display screen that is configured to display various information to the driver.

The display device DD can be a display that is capable of displaying information. As described herein, the information that is displayed can be at least one of status information of related to the vehicle V as is known in the art. Preferably, the display device DD includes a touch screen (or a user interface UI). Thus, in one embodiment, the display device DD functions as both the user interface and a notification device. The display device DD can include a graphical operator interface (GUI) to enable a vehicle V occupant to change settings in the vehicle V, operate the positioning system PS and provide any information input necessary for operation of the vehicle V and the vehicle control system 18.

The vehicle anti-hydroplaning system 10 can be incorporated into the vehicle control system 18, be a stand alone system or be operated in conjunction with the vehicle control system 18. In the illustrated embodiment, the vehicle anti-hydroplaning system 10 is part of the vehicle control system 18, and the controller 14 of the vehicle control system 18 operates as the controller 18 of the vehicle anti-hydroplaning system 10. However, it is understood that the vehicle anti-hydroplaning system 10 can have a separate controller to the controller of the vehicle control system 18, or be a system that operates without any vehicle control system, or in any combination or variation thereof.

Furthermore, the vehicle anti-hydroplaning system 10 can be operational during and/or in conjunction with any other vehicle control system. For example, the vehicle anti-hydroplaning system 10 can operate while the electronic stability control is active. It is noted that the vehicle anti-hydroplaning system 10 can operate while of the vehicle control systems are operational or without any of the vehicle control systems or in any other manner desired.

As shown in FIG. 2. the vehicle anti-hydroplaning system 10 includes the steering system 16, a sensor 12 and the controller 14. The steering system 16 is configured to operate the steerable wheels 20 of a vehicle. As discussed above, the steering system 16 can include the actuators 32. Thus, the actuators 32 are capable of operating the steerable wheels 20, so as to move the steerable wheels 20 to form an angle α with the longitudinal direction L of the vehicle V.

The sensor 12 is configured to sense a condition of the steerable wheels 20 of the vehicle. In one embodiment, the sensor 12 is configured to sense at least one of a vehicle wheel speed, an angle of the steerable wheels 20 and an amount of G-force on the vehicle. Thus, the sensor 12 can be at least one of a vehicle speed sensor 24, a steering angle sensor 26 and a G-force sensor 28. The sensor 12 can also be one or more of these sensors, or a combination of these sensors. The sensor 12 can also include the yaw rate sensor, a torque sensor, and/or the IMUs 30. In other words, the sensor 12 can be any sensor or device that is capable of providing information to the controller 14 that enables the controller 14 to determine the hydroplaning status of the vehicle V.

The sensor 12 can also in corporate date or information from the positioning system PS to determine location and movement direction of the vehicle V. For example, the can provide information to the controller 14 regarding the location, and thus the surface the vehicle V is disposed on and the vehicle direction on the road, among other information.

As discussed herein, the controller for the vehicle anti-hydroplaning system 10 can be the controller 14 described above or the controller can be a different or second controller. Regardless, the controller for the vehicle anti-hydroplaning system 10 is similar or identical to the controller 14 and any description thereof pertains to the controller 14 of the vehicle anti-hydroplaning system 10.

Thus, the controller 14 is configured to determine that and the vehicle is in a hydroplaning state based on the condition sensed by the sensor 12 and configured to perform a mitigation operation using the steering system 16 to improve traction of the steerable wheels 20 of the vehicle.

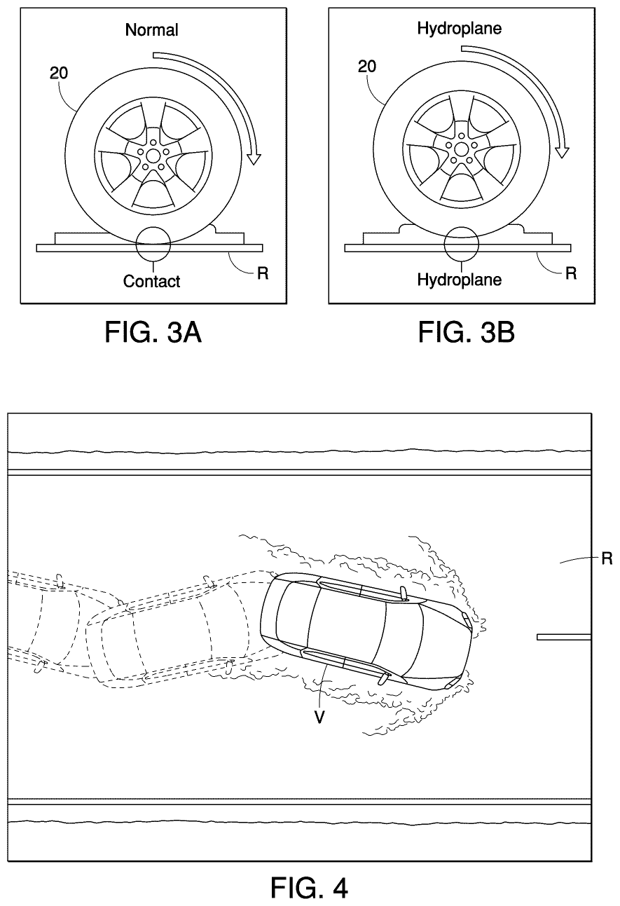

As illustrated in FIG. 3A, the wheel 20 of the vehicle V is in a normal condition in contact with a road surface R. In the normal condition, the tire of the wheel 20 includes tread grooves that channel water away from the tire's contact patch with the road. However, in some situations, the tire of the wheel can lose contact with the road surface R. As illustrated in FIG. 3B, a layer of water can be disposed between the tire's contact patch with the road. This layer of water can cause a loss of vehicle control. See for example FIG. 4, which illustrates the vehicle V in a hydroplaning situation with a loss of vehicle control.

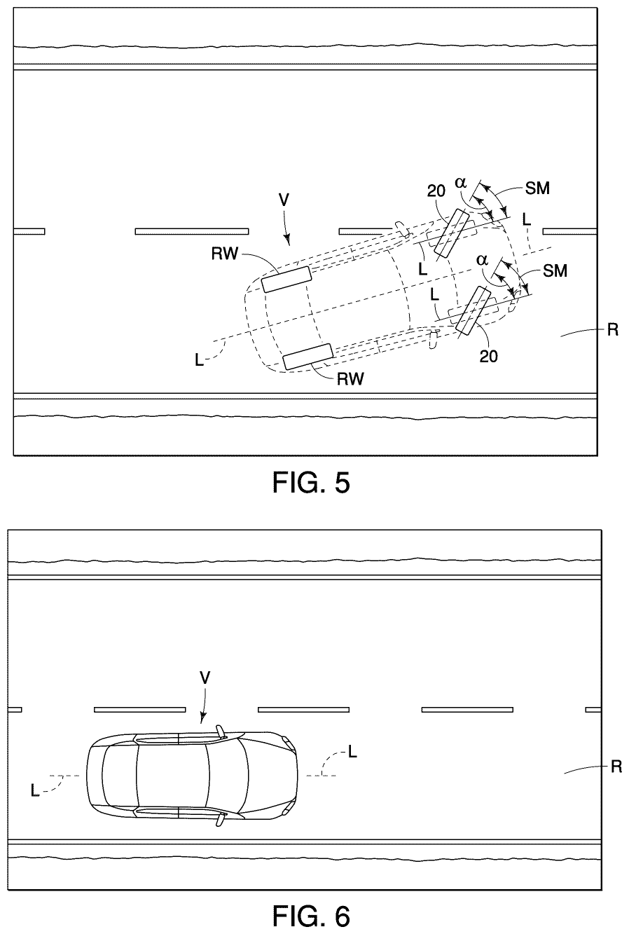

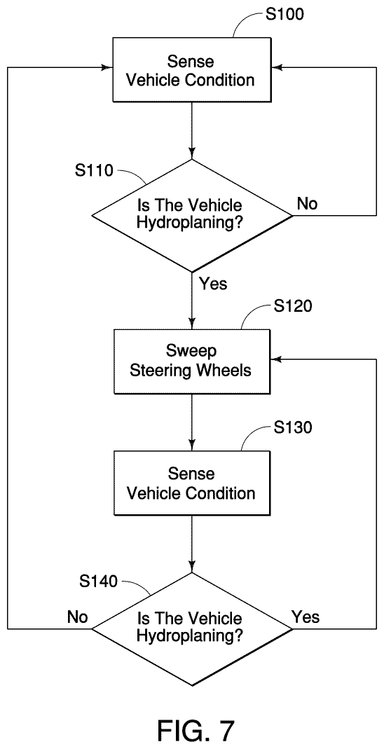

In one embodiment, as illustrated in FIGS. 2 and 5, the controller 14 is configured to perform the mitigation operation by causing the steering system 16 to perform a sweeping motion SM of the steerable wheels 20 of the vehicle. That is, the steering system 16 moves the steerable wheels 20 in an angular back and forth motion to sweep the steerable wheels 20. The sweeping motion SM can clear any material (e.g., water, sand, mud, etc.) that is between the traction surface of the tire of the vehicle V and the surface (e.g., the road R) on which the vehicle V is disposed. This mitigation operation, i.e., the sweeping motion SM of the steerable wheels 20, can be performed without the steering system 16 moving the steering wheel SW of the vehicle V. In other words, the vehicle anti-hydroplaning system 10 can mitigate or correct a vehicle hydroplaning situation by movement of the steerable wheels 20 without affecting the operational input (or even knowledge) of the vehicle operator.

The sweeping motion SM can be any suitable sweeping motion SM to mitigate or correct the vehicle hydroplaning situation. In one embodiment, the mitigation operation can include moving the steerable wheels 20 between an angle α of 5 -45 degrees from a longitudinal direction of the vehicle V. The mitigation operation can further include moving the steerable wheels 20 back and forth between about 0.2 cycles per second and 20 cycles per second. As can be understood, in some vehicles rotating the steering SW results in a 15 degree turn of the steerable wheels (α=15 degrees).

In one embodiment, the angle α and/or the frequency of the sweeping motion SM of each of the steerable wheels 20 is the same. However, in one embodiment, the angle α and/or the frequency of the sweeping motion SM of each of the steerable wheels 20 can be different. For example, the angle α and/or the frequency of the sweeping motion one of the steerable wheels 20 can be greater than or less than the angle α and/or the frequency of the sweeping motion of each of the steerable wheels 20. In one embodiment, only one of the steerable wheels 20 can move in a sweeping motion SM, while the other steerable wheel 20 does not angular change. In one embodiment, the angle α of one of the steerable wheels 20 is greater than the angle α of the other of the steerable wheels 20, and the frequency of the sweeping motion SM of the one of the steerable wheels 20 is less than the sweeping motion SM of the other of the steerable wheels 20.

In one embodiment, the angle α and/or the frequency of the sweeping motion is consistent. However, in one embodiment, the angle α and/or the frequency of the sweeping motion can change at regular or irregular intervals. For example, when the steerable wheels 20 are moved in one direction, the angle α and/or the frequency of the sweeping motion can each have a first value and when the steerable wheels 20 are moved in a second opposite direction, the angle α and/or the frequency of the sweeping motion can each have a second value. The first and second values can be the same or the first and second values can be different.

Accordingly, the controller 14 can be configured to operate the steering system 16 to provide a change in angle α of the steerable wheels 20 at 15-45 degrees in a frequency of about 0.2 cycles per second and 20 cycles per second. Such a mitigation operation corrects or mitigates the hydroplaning situation of the vehicle V.

FIG. 6 illustrates the vehicle after the hydroplaning situation has been completely corrected and the vehicle is traveling along the road R in the normal condition with the tire's contact patch in contact with the road

Furthermore, in one embodiment, the operator of the vehicle V is capable of operating the vehicle in a normal manner during the mitigation operation. That is, the operator of the vehicle V can move the steering wheel SW to change the angle of the steerable wheels 20 as is known in the art. This operational capability of the operator enables the operator to input correct action (or general operational inputs) into the steering system 16 simultaneously with the mitigation operation.

Since the steering system 16 is a drive by wire system, the controller 14 is capable of determining the input of the operator and the necessary input to correct or mitigate the hydroplaning situation of the vehicle V. Accordingly, the controller 14 mitigates or corrects the hydroplaning situation without operation of the steering wheel, while simultaneously determining operational input from the operator.

FIG. 9 is a flow chart illustrating the process performed by the vehicle anti-hydroplaning system 10 of the present disclosure. As is described herein the method mitigates or corrects a vehicle hydroplaning situation by increasing tire traction in the vehicle V.

The method provides or inputs machine-readable instructions for generating a mitigating a vehicle hydroplaning situation in accordance with the present disclosure. The machine-readable instructions are provided on a non-transitory machine-readable medium. One advantage of the process for mitigating or correcting a vehicle hydroplaning situation by increasing tire traction in the vehicle V described herein is that the same machine-readable instructions can be saved on any number of non-transitory machine-readable mediums.

Here, in step S100, the sensor 12 senses a condition of the steerable wheels 20 of the vehicle. The sensed information is transmitted to the controller 14, which determines whether the vehicle is in a hydroplaning state based on the condition sensed by the sensor 14 in Step S110. If the vehicle is not in a hydroplaning state (NO) the vehicle anti-hydroplaning system 10 continues to sense (or monitor) the vehicle condition.

If the controller 14 determines that the vehicle V is in a hydroplaning state (YES), the vehicle anti-hydroplaning system 10, via the controller 14 sends instructions to the steering system 16 to perform a mitigation operation using the steering system 16 to improve traction of the steerable wheels 20 of the vehicle. As discussed herein, the mitigation operation can be any suitable operation to correct or mitigate the hydroplaning state. The mitigation operation can include, but is not limited to, performing sweeping motion SM of the steerable wheels 20 of the vehicle by operation of the steering system 16 in Step S120.

In one embodiment, the steering system 16 is operated to provide a change in angle α of the steerable wheels 20 at 15-45 degrees in a frequency of about 0.2 cycles per second and 20 cycles per second without operation of the steering wheel. As can be understood, these parameters are merely an exemplary mitigation operation. As discussed above, since the steering system 16 is a steer by wire system, in one embodiment, the operator is not aware of the mitigation operation.

The sensor 12 continues to provide vehicle information to the controller 14, such that the controller 14 is capable of determining whether the vehicle is still in the hydroplaning state in step S130. The sensed information is transmitted to the controller 14, which determines whether the vehicle is in a hydroplaning state based on the condition sensed by the sensor 14 or if the hydroplaning situation has been corrected to mitigated (NO), in step S140. If the vehicle is no longer in the hydroplaning situation, the mitigation operation is terminated and the vehicle anti-hydroplaning system 10 returns to Step S100 and monitors or senses the vehicle condition.

If the controller 14 determines that the vehicle is still in the hydroplaning situation (YES), the vehicle anti-hydroplaning system 10 returns to Step S120 and continues to sweep the wheels until a determination is made that the vehicle is no longer in the hydroplaning situation.

It is noted that the controller 14 can alter the mitigation based on the sensed vehicle condition. That is, the controller 14 can determine the appropriate sweep angle α and sweep frequency based on factors such as, vehicle speed, surface on which the vehicle is disposed on, vehicle yaw, vehicle direction, wheel rotational speed, vehicle steerable wheels angle, amount of G-force on the vehicle and any other factors sensed by the sensor 12.

Moreover, the controller can adjust or change the parameters of the mitigation operation during the mitigation. For example, the controller can change the sweep angle or the frequency of the sweep during the mitigation based on the condition of the vehicle V or a change of the condition of the vehicle V to improve the mitigation operation.

### General Interpretation of Terms

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a vehicle equipped with the vehicle anti-hydroplaning system. Accordingly, these terms, as utilized to describe the present disclosure should be interpreted relative to a vehicle equipped with a vehicle anti-hydroplaning system.

The term “detect” as used herein to describe an operation or function carried out by a component, a section, a device or the like includes a component, a section, a device or the like that does not require physical detection, but rather includes determining, measuring, modeling, predicting or computing or the like to carry out the operation or function.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A vehicle anti-hydroplaning system, comprising:
a steering system configured to operate a steerable wheel of a vehicle;
a sensor configured to sense a condition of the steerable wheel of the vehicle; and
a controller configured to determine that and the vehicle is in a hydroplaning state based on the condition sensed by the sensor and configured to perform a mitigation operation using the steering system to improve traction of the steerable wheel of the vehicle.

2. The vehicle anti-hydroplaning system according to claim 1, wherein
the steering system is a steer by wire system.

3. The vehicle anti-hydroplaning system according to claim 2, wherein
the controller is configured to perform the mitigation operation by a sweeping motion of the steerable wheel of the vehicle.

4. The vehicle anti-hydroplaning system according to claim 3, wherein
the controller is configured to perform the mitigation operation without movement of a steering wheel of the vehicle.

5. The vehicle anti-hydroplaning system according to claim 1, wherein
the controller is configured to perform the mitigation operation by moving the steerable wheel between an angle of 5-45 degrees from a longitudinal direction of the vehicle.

6. The vehicle anti-hydroplaning system according to claim 1, wherein
the controller is configured to determine the mitigation operation based on at least one of a vehicle speed and a surface of which the steerable wheel are being operated.

7. The vehicle anti-hydroplaning system according to claim 1, wherein
the steering system is configured to accept operational input from a driver while the mitigation operation is being performed.

8. The vehicle anti-hydroplaning system according to claim 1, wherein
the controller is configured to perform the mitigation operation by moving the steerable wheel back and forth between about 0.2 cycles per second and 20 cycles per second.

9. The vehicle anti-hydroplaning system according to claim 1, wherein
the sensor configured to sense at least one of a vehicle wheel speed, an angle of the steerable wheels and an amount of G-force on the vehicle.

10. The vehicle anti-hydroplaning system according to claim 1, wherein
the steerable wheel is a first wheel, and the steering system is configured to operate the first and second steerable wheels.

11. A method of increasing tire traction in a vehicle, the method comprising:
sensing, via a sensor, a condition of the steerable wheel of the vehicle;
determining, via a controller, that and the vehicle is in a hydroplaning state based on the condition sensed by the sensors; and
performing, via the controller, a mitigation operation using a steering system to improve traction of the steerable wheels of the vehicle.

12. The method according to claim 11, wherein
the steering system is a steer by wire system.

13. The method according to claim 12, wherein
the performing the mitigation operation includes performing sweeping motion of the steerable wheels of the vehicle.

14. The method according to claim 13, wherein
the performing the mitigation operation includes performing the mitigation operation without movement of a steering wheel of the vehicle.

15. The method according to claim 11, wherein
the performing the mitigation operation includes moving the steerable wheels between an angle of 5-45 degrees from a longitudinal direction of the vehicle.

16. The method according to claim 11, wherein
the performing the mitigation operation includes performing the mitigation operation based on at least one of a vehicle speed and a surface of which the steerable wheels are being operated.

17. The method according to claim 11, wherein
the steering system is configured to accept operational input from a driver while the mitigation operation is being performed.

18. The method according to claim 11, wherein
performing the mitigation operation includes performing moving the steerable wheels back and forth between about 0.2 cycles per second and 20 cycles per second.

19. The method according to claim 11, wherein
the sensing includes sensing at least one of a vehicle wheel speed, an angle of the steerable wheels and an amount of G-force on the vehicle.

20. A non-transitory machine-readable medium storing instructions which, when executed by one or more processor, causes the one or more processor to execute the method of claim 11.

21. A vehicle controller comprising the non-transitory machine-readable medium of claim 20.
